(19) United States
(12) Patent Application Publication
(10) Pub. No.: US 2023/0024775 A1
(43) Pub. Date: Jan. 26, 2023

(54) APPARATUS AND METHOD TO FACILITATE TRANSFER OF CONSIDERATION BETWEEN INDIVIDUALS IN A COMMON GEOLOCATION

(71) Applicant: Buzz Capital Inc., Santa Monica, CA (US)

(72) Inventors: Mohamed ROSTOM, Santa Monica, CA (US); Lara MITCHELL, Santa Monica, CA (US)

(21) Appl. No.: 17/814,193

(22) Filed: Jul. 21, 2022

Related U.S. Application Data
(60) Provisional application No. 63/224,803, filed on Jul. 22, 2021.

(51) Int. Cl. G06Q 20/40; G06Q 20/32

(52) U.S. Cl. CPC G06Q 20/4015; G06Q 20/322

(57) ABSTRACT

A networked machine has a network interface to provide connectivity to a network. The network interface hosts a first network connection that receives geolocation information from users operating common client applications on client machines, and a second network connection that accesses credit data for the users from creditor machines. A processor is connected to the network interface. A memory is connected to the processor. The memory stores instructions executed by the processor to analyze consideration transfer input from a sending user in a common geolocation as one or more potential recipient users, authorize a transaction based upon the consideration transfer input, transfer funds between an account associated with the sending user and an account associated with a recipient user, and notify, via network communications, the sending user and the recipient user of the transaction.

### CROSS-REFERENCE TO RELATED APPLICATION

This application claims priority to U.S. Provisional Patent Application Ser. No. 63/224,803, filed Jul. 22, 2021, the contents of which are incorporated herein by reference.

### FIELD OF THE INVENTION

This invention relates generally to communications between networked machines. More particularly, this invention is directed toward techniques to facilitate transfer of consideration between individuals in a common geolocation.

### BACKGROUND OF THE INVENTION

The user of paper currency continues to decline in view of new digital payment methods. There is a need for individuals to transfer consideration to other individuals in a common geolocation without relying upon paper currency.

### SUMMARY OF THE INVENTION

A networked machine has a network interface to provide connectivity to a network. The network interface hosts a first network connection that receives geolocation information from users operating common client applications on client machines, and a second network connection that accesses credit data for the users from creditor machines. A processor is connected to the network interface. A memory is connected to the processor. The memory stores instructions executed by the processor to analyze consideration transfer input from a sending user in a common geolocation as one or more potential recipient users, authorize a transaction based upon the consideration transfer input, transfer funds between an account associated with the sending user and an account associated with a recipient user, and notify, via network communications, the sending user and the recipient user of the transaction.

### BRIEF DESCRIPTION OF THE FIGURES

The invention is more fully appreciated in connection with the following detailed description taken in conjunction with the accompanying drawings, in which:

FIG. 1 illustrates a system 100 configured in accordance with an embodiment of the invention.

FIG. 2 illustrates machine interactions performed in accordance with an embodiment of the invention.

FIG. 3 illustrates a graphical user interface utilized in accordance with an embodiment of the invention.

FIG. 4 illustrates a graphical user interface with selected elements to initiate a transaction in accordance with an embodiment of the invention.

Like reference numerals refer to corresponding parts throughout the several views of the drawings.

### DETAILED DESCRIPTION OF THE INVENTION

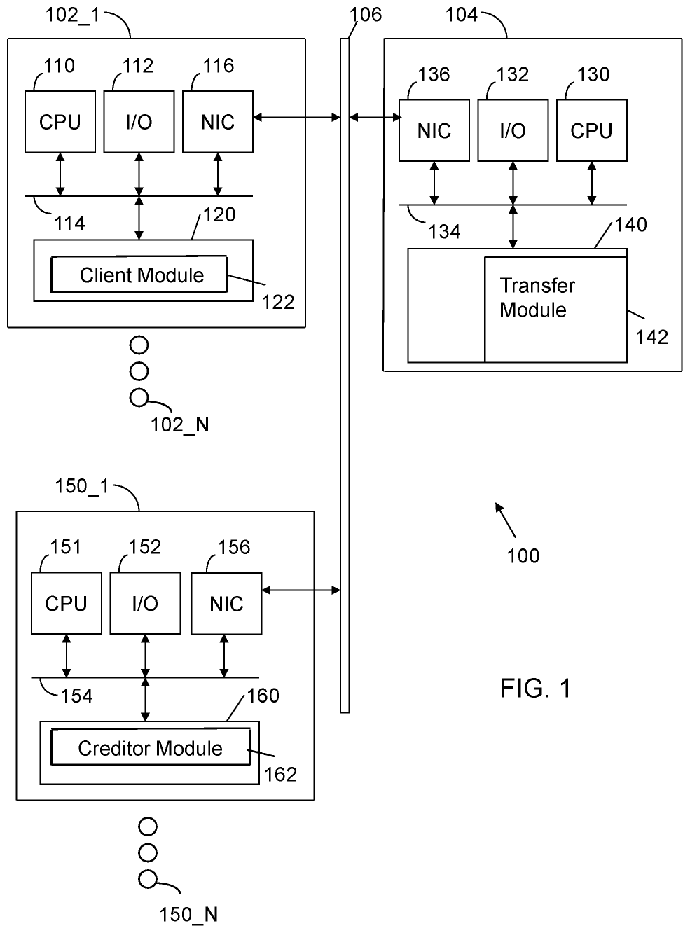

FIG. 1 illustrates a system 100 configured in accordance with an embodiment of the invention. The system 100 includes a set of client devices 102_1 through 102_N connected to a server 104 via a network 106, which may be any combination of wired and wireless networks.

Client machine 102_1 includes a processor (e.g., CPU) 110 connected to input/output devices 112 via a bus 114. The input/output devices 112 may include a keyboard, mouse, touch display and the like. A network interface circuit 116 is also connected to the bus 114. The network interface circuit 116 provides connectivity to network 106. A memory 120 is also connected to the bus 114. The memory 120 stores a client module 122 with instructions executed by processor 110. The client module is a client application to implement operations disclosed herein. Client machine 102_1 may be a computer, tablet, smartphone and the like.

Server 104 includes a processor 130, input/output devices 132, a bus 134 and a network interface circuit 136. A memory 140 is connected to the bus 134. The memory 140 stores a transfer module 142 with instructions executed by processor 130 to implement operations disclosed herein. In particular, the transfer module 142 coordinates the exchange of consideration between individuals operating client devices in a common geolocation.

Creditor machines 150_1 through 150_N are also connected to network 106. Creditor machine 150_1 includes a processor 151, input/output devices 152, a bus 154 and a network interface circuit 156. A memory 160 is connected to the bus 154. The memory 160 stores a creditor module 162 with instructions executed by processor 151. The creditor module 162 may be a bank facility, a credit card facility or other funding source used to exchange consideration between users of client machines 102_1 through 102_N. The transfer module 142 may communicate with the creditor machines 150_1 through 150_N to coordinate transactions. The transfer module 142 may also collect funds from the creditor machines 150_1 through 150_N and then coordinate transactions between users of client machines 102_1 through 102_N.

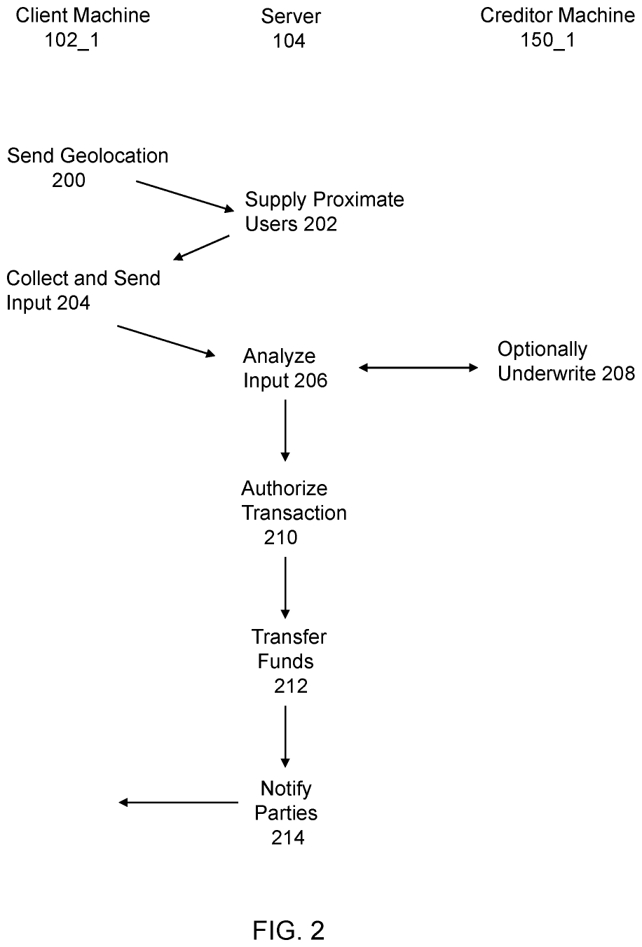

FIG. 2 illustrates operations performed between the machines of FIG. 1. Client machine 102_1 opens the client module 122, which results in the client module 122 sending the geolocation 200 of the user of the client machine 102_1 to server 104. The transfer module 142 of server 104 maintains geolocation information for users of the client machines 102_1 through 102_N that are logged into client module 122. Consequently, server 104 can supply a list of proximate users 202 to client machine 102_1.

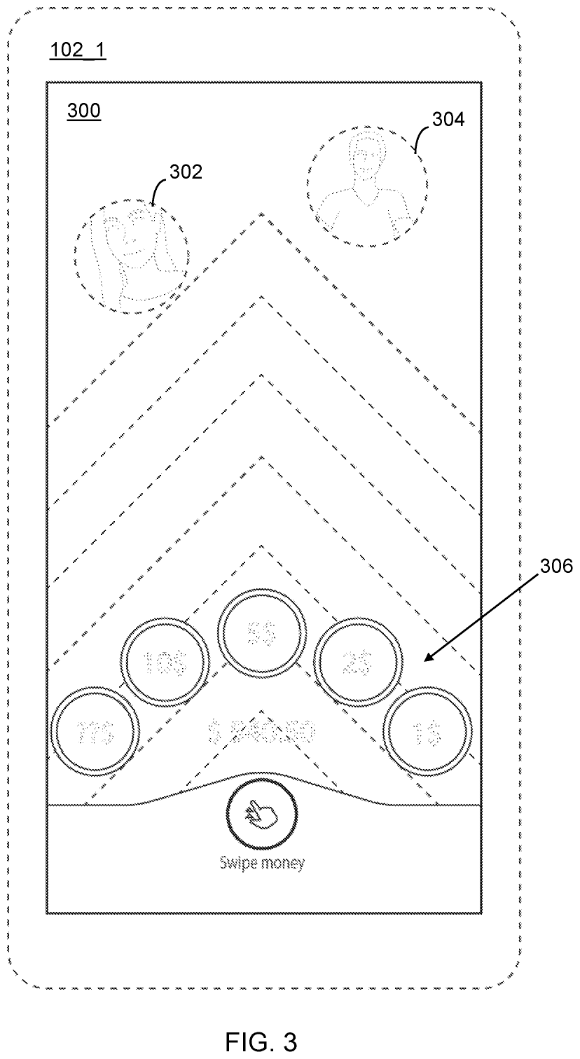

FIG. 3 illustrates client machine 102_1 in the form of a mobile device with a user interface 300 supplied by the transfer module 142. The user interface 300 shows users 302 and 304 in the same geolocation as the user of client device 102_1. The user interface 300 also includes a remittance region 306 that specifies different amounts of consideration that can be sent to a machine operated by a proximate user.

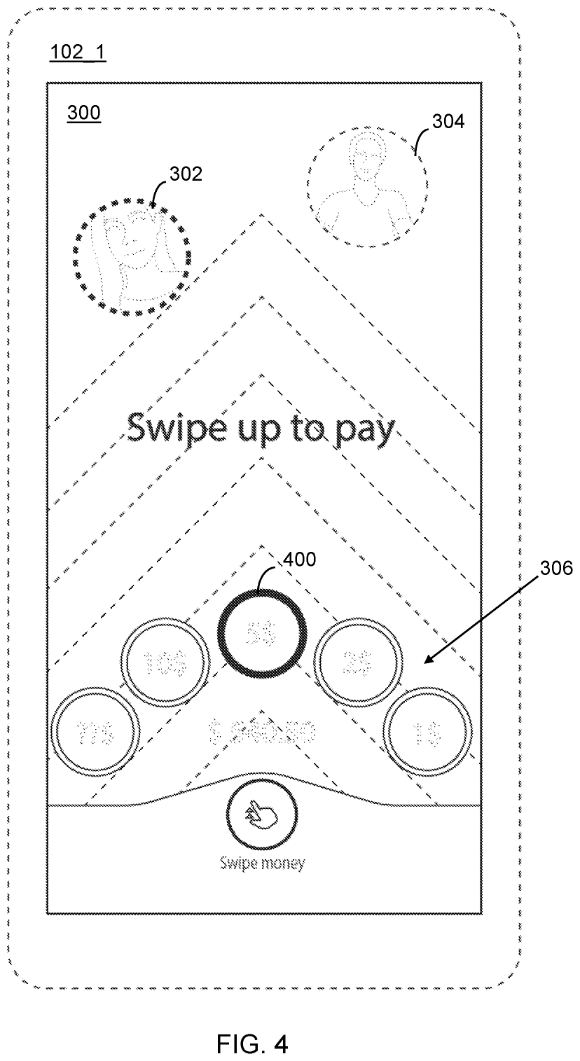

Returning to FIG. 2, the user interface 300 is used to collect and send input 204. For example, FIG. 4 illustrates the selection of user 302. For example, haptic contact with the region of interface 300 associated with user 302 may result in highlighted indicia, in this case bold lines, indicating selection of user 302. Similar interactions may be used to select an amount of consideration from remittance region 306. In this example, region 400 is selected and highlighted. After a user and a remittance amount are selected, the user is prompted to swipe (e.g., perform an upward haptic motion on the display of the client device 102_1) to complete the transfer request.

Returning to FIG. 2, the input is analyzed 206 by the transfer module 142 of server 104. The analysis includes verification that there are sufficient funds in the user's account to cover the transfer of consideration. The funds may be associated with server 104 and/or the server 104 may interact with a creditor machine 150_1, which may optionally underwrite 208 the transaction.

Subsequently, the transaction is authorized 210. The funds are then transferred 212 from the sender to the receiver. The parties are then notified 214. In this example, a notification is sent to the sender associated with client machine 102_1 and to a receiver at another client machine, say machine 102_N.

The client module 122 may have instructions executed by the processor 110 to coordinate a registration process in which the user is prompted to take a picture of herself, so that it can be subsequently used, such as shown as element 302 in FIG. 3.

As previously indicated, the transfer module 142 may maintain clusters of users within the same geolocation. Alternately, or in addition, the client module 122 may use wireless technology (e.g., Bluetooth) to identify system users in a peer-to-peer manner.

In an embodiment of the invention, the server 104 sends a confirmation screen to the client machine 102_1. The confirmation screen specifies the recipient and the amount and prompts the user for a confirmation of the accuracy of the information. In one embodiment, facial recognition techniques are used to confirm a recipient. For example, the user is prompted to use the camera on the client device 102_1 to take an image of the intended recipient. The facial features are then compared to those already stored in transfer module 142.

It is readily appreciated that the disclosed technology facilitates payments between individuals in a common geolocation. This is particularly helpful in the case of tipping service workers, splitting the expense of a meal between friends, and countless other scenarios. The simple interface and the authorizing backend system provide unprecedent ease for client device users.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A networked machine, comprising:
a network interface to provide connectivity to a network, including:
(1) a first network connection that receives geolocation information from users operating common client applications on client machines,
(2) a second network connection that accesses credit data for the users from creditor machines;
a processor connected to the network interface; and
a memory connected to the processor, the memory storing instructions executed by the processor to:
analyze consideration transfer input from a sending user in a common geolocation as one or more potential recipient users,
authorize a transaction based upon the consideration transfer input,
transfer funds between an account associated with the sending user and an account associated with a recipient user, and
notify, via network communications, the sending user and the recipient user of the transaction.

2. The networked machine of claim 1 wherein the operation to analyze the consideration transfer input includes an analysis of an account balance for the sending user.

3. The networked machine of claim 2 wherein the analysis includes network communication with a creditor machine.

4. The networked machine of claim 1 further comprising instructions executed by the processor to supply to a sending user client machine the potential recipient users.

5. The networked machine of claim 1 further comprising instructions executed by the processor to send to a sending user client machine a user interface to prompt the sending user to specify a recipient user and a recipient consideration amount.

6. The networked machine of claim 5 wherein the user interface highlights a selected recipient user and a selected recipient consideration amount.

7. The networked machine of claim 6 wherein the user interface prompts the sending user to use a swipe gesture on a display of the sending user client machine to initiate the transfer of funds.

8. The networked machine of claim 7 wherein the user interface prompts the user for confirmation after the swipe gesture.
